(19) United States
(12) Patent Application Publication
(10) Pub. No.: US 2025/0070976 A1
(43) Pub. Date: Feb. 27, 2025

(54) SYSTEMS AND METHODS FOR UPGRADABLE SMART CONTRACT FACTORIES

(71) Applicant: DK Crown Holdings Inc., Boston, MA (US)

(72) Inventors: Mohammad Reza Kavian, Toronto (CA); Benjamin Ilan Weinberg, Toronto (CA)

(73) Assignee: DK Crown Holdings Inc., Boston, MA (US)

(21) Appl. No.: 18/454,610

(22) Filed: Aug. 23, 2023

(51) Int. Cl. H04L 9/32; H04L 9/00

(52) U.S. Cl. CPC H04L 9/3213; H04L 9/50

(57) ABSTRACT

Systems and methods for upgradable smart contract factories are disclosed. A system can provide, on a blockchain of a blockchain network, a beacon contract configured to (i) deploy proxy contracts in response to corresponding requests and (ii) maintain a list of a plurality of implementation contracts stored on the blockchain. Each implementation contract can corresponding to a respective token type. The system can invoke the beacon contract to deploy a first proxy contract corresponding to processing of a first token type, contract causing the blockchain network to determine that the list includes an implementation contract corresponding to the first token type, generate the first proxy contract on the blockchain, and provide an address of the first proxy contract in response to the request.

### BACKGROUND

Non-fungible tokens (NFTs) are created or “minted” using blockchain technology. Various NFTs may be minted using smart contracts, which may be software with pre-defined rules that is encoded on the blockchain. Smart contracts may be executed by nodes in a blockchain network to mint NFTs by writing transactions to the blockchain.

### SUMMARY

Conventional smart contracts are non-upgradable and immutable on the blockchain, which results in a number of technical disadvantages. For example, bugs or errors identified in a non-upgradable smart contract cannot be fixed without deploying a new contract and migrating all relevant data to the new contract, which is a complex and expensive process. Such smart contracts risk becoming obsolete and therefore unusable. These difficulties are compounded when a non-upgradable smart contract is referenced (e.g., called) by other smart contracts, in which case both the non-upgradable contract and the contracts that make calls to the non-upgradable contract must be redeployed when upgrades are required.

The systems and methods of this technical solution resolve these issues by providing a beacon smart contract that generates proxy contracts on the blockchain that make calls to the beacon smart contract to retrieve addresses of corresponding implementation contracts. The beacon smart contract, in connection with the deployed proxy smart contracts, thereby implements a beacon proxy smart contract scheme. A beacon proxy smart contract scheme involves using a beacon contract to store the address of one or more implementation contracts. Implementation contracts store up-to-date executable code to process tokens defined on the blockchain. Proxy smart contracts make calls to the beacon contract to retrieve addresses for, and subsequently execute, the most up-to-date versions of implementation contract(s) deployed on the blockchain.

The beacon smart contract described herein can be updated to store addresses of new or replacement implementation contracts, thereby enabling several proxy contracts to execute upgraded or replacement logic without redeploying large numbers of smart contracts to the blockchain. The beacon contract may provide contract factory functionality by deploying additional proxy contracts based on corresponding requests. The use of a beacon contract enables multiple proxies to be upgraded simultaneously by changing the address of one or more implementation contracts in the beacon contract, thereby reducing overall blockchain network load by reducing the number of contracts that must be redeployed on the blockchain in the event of an implementation upgrade. The ability to deploy additional proxy contracts that retrieve corresponding implementations from the beacon contract further improves the performance of the blockchain by reducing the number of contracts that must be manually deployed or redeployed. The techniques described herein therefore provide technical improvements to blockchain processing systems that implement smart contracts.

One aspect of the present disclosure is directed to a method. The method may be performed, for example, by one or more processors coupled to memory. The method includes providing, on a blockchain of a blockchain network, a beacon contract configured to (i) deploy proxy contracts in response to corresponding requests and (ii) maintain a list of a plurality of implementation contracts stored on the blockchain. Each implementation contract corresponds to a respective token type. The method includes invoking the beacon contract based on a request to deploy a first proxy contract. The first proxy contract corresponds to processing of a first token type. The invocation of the beacon contract causes the blockchain network to determine that the list of the plurality of implementation contracts includes an implementation contract corresponding to the first token type; generate, on the blockchain responsive to the determination, the first proxy contract comprising a first address of the beacon contract; and provide, on the blockchain, a second address of the first proxy contract in response to the request. The method includes invoking the first proxy contract on the blockchain using the second address of the first proxy contract.

In some implementations, the method includes storing the second address of the first proxy contract in a storage system different from the blockchain. In some implementations, invoking the first proxy contract on the blockchain causes the blockchain network to execute the first proxy contract based on the first address of the beacon contract. In some implementations, invoking the first proxy contract causes the blockchain network to retrieve a third address of the implementation contract corresponding to the first token type via the beacon contract. In some implementations, retrieving the third address of the implementation contract corresponding to the first token type causes the blockchain network to select an identifier of the implementation contract corresponding to the first token type from the list of the plurality of implementation contracts; and provide the identifier of the implementation contract corresponding to the first token type as the third address of the implementation contract.

In some implementations, the method includes providing a second request to update the implementation contract corresponding to the first token type, the second request comprising an identifier of an additional implementation contract. In some implementations, the second request causes the blockchain network to replace the identifier of the implementation contract corresponding to the first token type with the identifier of the additional implementation contract. In some implementations, the method includes invoking the first proxy contract on the blockchain using the second address of the first proxy contract, causing the blockchain network to retrieve the identifier of the additional implementation contract via the beacon contract.

In some implementations, the method includes causing generation of a token having the first token type by invoking the implementation contract corresponding to the first token type via a second request identifying the first proxy contract. In some implementations, the method includes, upon receiving confirmation that the token has been generated, storing a set of metadata corresponding to the token in a storage system different from the blockchain. In some implementations, the method includes determining that the first proxy contract has been deployed on the blockchain; and providing an indication that the first proxy contract has been deployed on the blockchain, the indication comprising the second address of the first proxy contract.

One other aspect of the present disclosure is directed to a system. The system includes one or more processors coupled to memory. The system can provide, on a blockchain of a blockchain network, a beacon contract configured to (i) deploy proxy contracts in response to corresponding requests and (ii) maintain a list of a plurality of implementation contracts stored on the blockchain. Each implementation contract corresponds to a respective token type. The system can invoke the beacon contract based on a request to deploy a first proxy contract, where the first proxy contract corresponds to processing of a first token type. The invocation of the beacon contract causes the blockchain network to determine that the list of the plurality of implementation contracts includes an implementation contract corresponding to the first token type; generate, on the blockchain responsive to the determination, the first proxy contract comprising a first address of the beacon contract; and provide, on the blockchain, a second address of the first proxy contract in response to the request. The system can invoke the first proxy contract on the blockchain using the second address of the first proxy contract.

In some implementations, the system can store the second address of the first proxy contract in a storage system different from the blockchain. In some implementations, invoking the first proxy contract on the blockchain causes the blockchain network to execute the first proxy contract based on the first address of the beacon contract. In some implementations, invoking the first proxy contract causes the blockchain network to retrieve a third address of the implementation contract corresponding to the first token type via the beacon contract. In some implementations, retrieving the third address of the implementation contract corresponding to the first token type causes the blockchain network to select an identifier of the implementation contract corresponding to the first token type from the list of the plurality of implementation contracts; and provide the identifier of the implementation contract corresponding to the first token type as the third address of the implementation contract.

In some implementations, the system can provide a second request to update the implementation contract corresponding to the first token type. In some implementations, the second request comprises an identifier of an additional implementation contract. In some implementations, the second request causes the blockchain network to replace the identifier of the implementation contract corresponding to the first token type with the identifier of the additional implementation contract. In some implementations, the system can invoke the first proxy contract on the blockchain using the second address of the first proxy contract, causing the blockchain network to retrieve the identifier of the additional implementation contract via the beacon contract.

In some implementations, the system can cause generation of a token having the first token type by invoking the implementation contract corresponding to the first token type via a second request identifying the first proxy contract. In some implementations, the system can, upon receiving confirmation that the token has been generated, store a set of metadata corresponding to the token in a storage system different from the blockchain. In some implementations, the system can determine that the first proxy contract has been deployed on the blockchain; and provide an indication that the first proxy contract has been deployed on the blockchain, the indication comprising the second address of the first proxy contract.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated into and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular forms of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of an example data processing system for providing improved and upgradable smart contract factories, in accordance with one or more implementations;

FIG. 2 illustrates an example dataflow diagram showing how a beacon contract can deploy proxy contracts and maintain lists of implementation contract addresses, in accordance with one or more implementations;

FIG. 3 illustrates a flow diagram of an example method of providing improved and upgradable smart contract factories, in accordance with one or more implementations; and

FIG. 4 is a block diagram of an example data processing system and computing environment that may be utilized to perform various techniques or operations described herein, in accordance with one or more implementations.

### DETAILED DESCRIPTION

The systems and methods described herein improve upon conventional blockchain systems that execute smart contracts by providing a beacon contract that can both deploy proxy contracts and maintain lists of implementation contract addresses. The techniques described herein reduce overall computation strain on the blockchain network, and reduce gas costs to provide and upgrade smart contracts that may operate on tokens, such as non-fungible tokens (NFTs). In conventional smart contract schemes, each contract is upgraded individually, which is time-consuming and expensive, especially if there are a large number of contracts. This computational strain is increased when upgraded contracts are referenced by other contracts, such as proxy contracts. Because smart contracts on the blockchain are immutable, each proxy contract must also be individually updated when a corresponding implementation contract is changed. This causes decreased blockchain network performance and introduces latencies in upgrading smart contracts

The techniques described herein solve these and other issues by implementing a beacon contract that both deploys additional proxy contracts on the blockchain (e.g., as a factory), while acting as a beacon by providing addresses of corresponding implementation contracts. In this manner, additional proxy contracts may be deployed in response to corresponding requests, while implementation contracts may be replaced and upgraded as needed without requiring redeployment of proxy contracts that access and execute said implementation contracts. To do so, the systems and methods described herein can provide a beacon contract where addresses of one or more implementation contracts can be changed, such that the beacon contract can provide an up-to-date address for each implementation contract that may be invoked by corresponding proxy contracts The ability to deploy additional proxy contracts that retrieve corresponding implementations from the beacon contract further improves the performance of the blockchain by reducing the number of contracts that must be manually deployed or redeployed. The techniques described herein therefore provide technical improvements to blockchain processing systems that implement smart contracts.

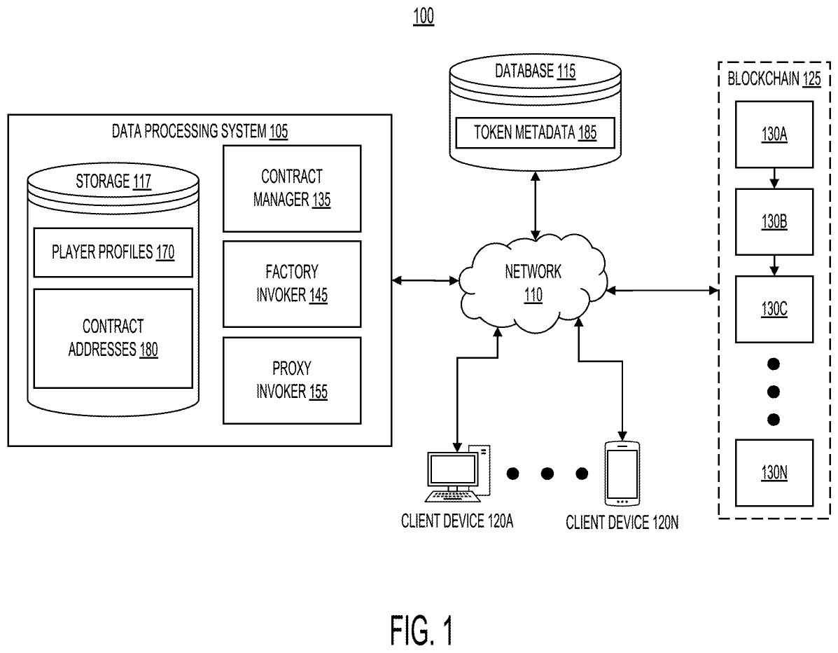

Referring now to FIG. 1, a system 100 is shown that includes a data processing system 105, a database 115, one or more client devices 120A-120N (sometimes generally referred to in the singular or the plural as “client device(s) 120”) and a blockchain network 125. The data processing system 105 can improved and upgradable smart contract factories, which serve as beacon contracts on the blockchain network 125. The data processing system 105 can be a server system, a cloud-computing platform, a local computing system, a node in a distributed network, a desktop computer, a client device, or any other system that can process information. The data processing system 105 can be or include one or multiple computing nodes, servers, or distributed processing systems. The data processing system 105 can include a contract manager 135, a factory invoker 145, a proxy invoker 155, and storage 117. The contract manager 135, the factory invoker 145, the proxy invoker 155, and the storage 117 can include software, applications, scripts, code, objects, hardware, or the like (or combinations thereof) that are configured to perform the various tasks, operations, and techniques described herein.

The contract manager 135, the factory invoker 145, the proxy invoker 155, and the storage 117 can be implemented on a single data processing system 105 or implemented on multiple, separate data processing systems 105. The contract manager 135, the factory invoker 145, the proxy invoker 155, and the storage 117 can include portions of computer software, modules, software components, combinations of hardware and software components, or the like. Although various processes are described herein as being performed by the data processing system 105, it should be understood that said operations or techniques may also be performed by other computing devices (e.g., one or more client devices 120, nodes of the blockchain network 125, etc.), either individually or via communications with the data processing system 105. Similarly, the client device 120 may include one or more of the components (e.g., the contract manager 135, the factory invoker 145, the proxy invoker 155, the storage 117) of the data processing system 105, and may carry out any of the various functionalities described herein.

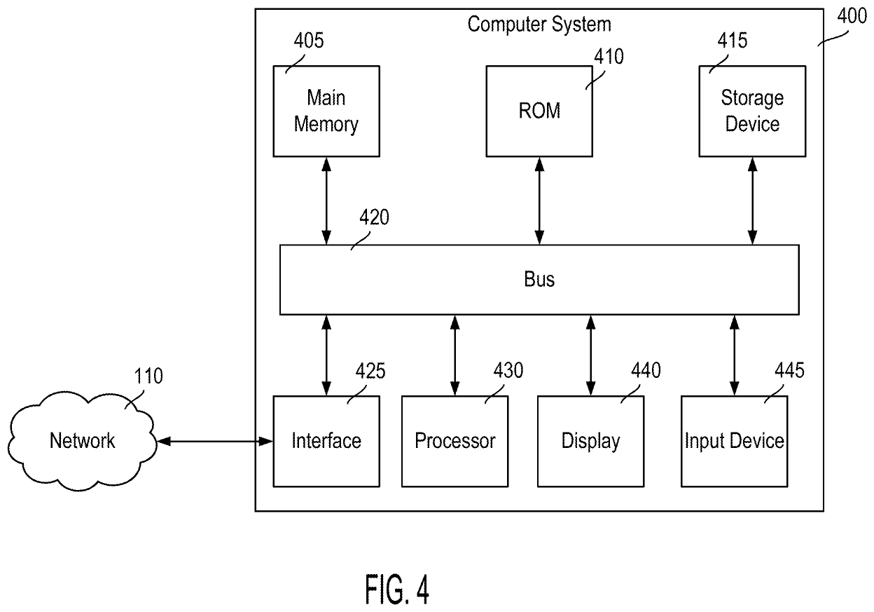

The data processing system 105 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), a graphics processing unit (GPU), a tensor processing unit (TPU), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein. The data processing system 105 can include any or all the components and perform any or all the functions of the computer system 400 described in connection with FIG. 4.

The network 110 can include computer networks such as the Internet, local, wide, metro or other area networks, intranets, satellite networks, other computer networks, such as mobile phone (voice or data) communication networks, or combinations thereof. The data processing system 105 of the system 100 can communicate via the network 110 with one or more computing devices, such as the one or more client devices 120. The network 110 may be any form of computer network that can relay information between the data processing system 105, the one or more client devices 120, the database 115, the blockchain network 125, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive or transmit data within the network 110.

The network 110 may further include any number of hardwired or wireless connections. Any or all of the computing devices described herein (e.g., the data processing system 105, the one or more client devices 120, the computer system 100, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client devices 120, the computer system 100, etc.) may also communicate wirelessly with the computing devices of the network 110 via a proxy device (e.g., a router, network switch, or gateway).

The database 115 can be or include a data repository, a database, a set of databases a storage medium, or non-transitory memory device(s), among others. The database 115 is shown, in this example, as being external to the data processing system 105. However, in some implementations, the database 115 may be internal to the data processing system 105. The database 115 may be associated with a database URI, which may identify a location of a file, script, or network-addressable location of the database 115 that enables access to the token metadata 185. For example, the database URI may be a network address for the database 115, or a directory, filesystem, or memory structure stored within the database 115, which may be utilized to access the functionality of the database 115. The contents of the database 115 may be accessed or using one or more application programming interfaces (APIs) (e.g., a REST API) or software using the URI. In an example, the database URI may point, for example, to a cloud storage bucket, a key, a portion of a key, or combinations thereof, to access, retrieve, modify, delete, or create any of the information described herein, including token metadata 185.

Token metadata 185 for a token (e.g., an NFT minted on the blockchain via one or more contracts, etc.) can be stored in association with, and may be accessed based on, a corresponding token identifier that uniquely identifies the token. The token metadata 185 for a particular token may be created, deleted, retrieved, modified, or otherwise accessed using a corresponding URI that accesses the token metadata 185 within the database 115. The database 115 can store corresponding token metadata 185 for any number of tokens and token types, including NFTs (e.g., ERC-721 tokens). The token metadata 185 may include any information relating to the token to which it corresponds. The token metadata 185 may be stored, for example, in the JavaScript Object Notation (JSON) format. The token metadata 185 for a token may include, but is not limited to, a token name, a token description, an image, thumbnail, graphic, audio, video, or other content (e.g., media files), creator information, date of creation, edition information (e.g., an edition number, collection identifier, pack identifier, promotion identifier, etc.), rarity information (e.g., a rarity value corresponding to a “common”, “elite” or “legendary”, etc.), or other attributes, such as a “superstar” attribute. In some implementations, the token metadata 185 for a token may include an identifier of an athlete, identifiers of one or more fantasy sports contests in which the token has been an entrant, outcomes of any past fantasy sports contests in which the token was entered, an identifier of a team corresponding to the token (e.g., a sports team for the athlete identified in the token, etc.), or any other information relating to fantasy sports.

Although shown here as external to the data processing system 105, the database 115 may, in some implementations, be internal to the data processing system 105. In some implementations, the database 115 may, for example, be part of a cloud computing system or an external computing device in communication with the devices (e.g., the data processing system 105, the client devices 120, etc.) of the system 100 via the network 110. The database 115 may store any other information described herein, including token identifiers, metadata URIs, database URI(s), or any other information described herein. In some implementations, the database 115 may implement authentication procedures (e.g., key sharing, encryption, etc.) such that only the data processing system 105 can modify the token metadata 185 of a token. In some implementations, the client devices 120 may have read access, but cannot modify, the contents of the database 115. In some implementations, the database 115 may not authorize access to the client devices 120. In such implementations, the client devices 120 may transmit a request to access the token metadata 185 to the data processing system 105, which can retrieve and provide the token metadata 185 to the requesting client device 120. Token metadata 185 may be generated by the data processing system 105, for example, when a token is minted on the blockchain. The token metadata 185 for a token can include the identifier of the minted token, which may be retrieved from the blockchain network 125.

Each of the client devices 120 can include at least one processor and a memory (e.g., a processing circuit). The memory can store processor-executable instructions that, when executed by the processor, cause the processor to perform one or more of the operations described herein. The processor can include a microprocessor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 120 can include one or more computing devices or servers that can perform various operations as described herein. The one or more client devices 120 can include any or all of the components and perform any or all of the functions of the computer system 100, described herein in conjunction with FIGS. 1A-1D. The client devices 120 may be or may include any of the structure or functionality of the computing system 400, described in connection with FIG. 4.

Each client device 120 can be a personal computer, a laptop computer, a television device, a smart phone device, a mobile device, or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, etc.). Each client device 120 may include one or more I/O devices (e.g., a mouse, a keyboard, digital keypad, buttons, trackpads, touch sensor of the touchscreen, etc.). The display can include a touch screen displaying an application, such as a web browser application or a native application, which may be used to access the functionality of the data processing system 105, as described herein.

A client device 120 can receive interactions from a player. The client device 120 may also receive interactions via any other type of I/O device. The interactions can result in interaction data, which can be stored and transmitted by the processing circuitry of the client device 120. The interaction data can include, for example, interaction coordinates, an interaction type (e.g., drag, click, swipe, scroll, tap, etc.), and an indication of an actionable object (e.g., an interactive user-interface element, such as a button, hyperlink, etc.) with which the interaction occurred. The interaction data can identify a user-interface element with which the interaction occurred.

Each client device 120 can include an input device that couples or communicates with the display of each client device 120 to enable a player to interact with or select one or more actionable objects as described herein. The display can enable interaction with one or more visual indications provided through the display of each client device 120, and be responsive to an interaction (e.g., select, click-on, touch, hover). The client device 120 can generate an indication identifying a user input or selection of a wager, a live event, a contest, an NFT, or submittal of a lineup, among others.

Each of the client devices 120 can include or be identified by a device identifier, which can be specific to each respective client device 120. The device identifier can include a script, code, label, or marker that identifies a particular client device 120. In some implementations, the device identifier can include a string or plurality of numbers, letters, characters, or any combination of numbers, letters, and characters. In some embodiments, each client device 120 can have a unique device identifier. Each client device 120 can include a client application, which can be a web browser or a native application that communicates with the data processing system 105 to present user interfaces, enter NFTs into contests, request retrieval of token metadata 185, generate one or more data records corresponding to a live event (e.g., a post, a wager, etc.), or other functionality described herein. The application interfaces can, for example, be application interfaces that present different types of configuration interfaces for various tokens minted by data processing system 105, such as an interface to update a lineup of contests or a selection to retrieve or access token metadata 185 of one or more tokens minted via the data processing system, among other functionalities. The client application can be executing on each client device 120 and may be provided to the client device 120 by the data processing system 105 or via an application distribution platform. The application can include a web application, a server application, a resource, a desktop, or a file.

The application can include a local application (e.g., local to a client device 120), hosted application, a SaaS application, a virtual application, a mobile application, or other forms of content. In some implementations, the application can include or correspond to applications provided by remote servers or third-party servers. In some implementations, the application can access the player profiles 170, the contract addresses 180, or token metadata 185 stored and maintained in the storage 117 and the database 115. The application may generate or otherwise present one or more interactive user-interface elements, include user-selectable hyperlinks, buttons, graphics, videos, images, or other interactive elements to control the functionality of the application make corresponding requests to the data processing system 105 to perform any of the techniques described herein. Interactions with such interactive user-interface elements (sometimes referred to as “actionable objects”) can cause the application executing on the respective client device 120 to generate a signal, which can cause the application to perform further operations corresponding to the actionable object.

In some implementations, one or more client devices 120 can establish one or more communication sessions with the data processing system 105. A communication session can include a channel or connection between the data processing system 105 and a respective client device 120. The one or more communication sessions can each include an application session (e.g., virtual application), an execution session, a desktop session, a hosted desktop session, a terminal services session, a browser session, a remote desktop session, a URL session or a remote application session. Each communication session can include encrypted or secure sessions, which can include encrypted files, data, or traffic. The session may be established based on information of a player profile 170 of a user accessing the functionality of the data processing system 105.

In some implementations, in response to interactions with corresponding user-interface elements, the application executing on a client device 120 can transmit information, such as player profile 170 information (e.g., changing player profile 170 parameters, changing login information, etc.), interaction information, selections of wager amounts, selections to input tokens into a lineup, selections to request information about the status of a contest, selections to request token metadata 185 of one or more tokens associated with the player profile 170 of the player, among other selections or requests described herein. For example, the client device 120 can transmit a request to invoke one or more proxy contracts, for example, to mint one or more tokens (e.g., NFTs) via the blockchain network 125. In another example, the client device 120 can transmit a request to generate an additional proxy contract (e.g., a proxy contract 205) on the blockchain via a beacon contract (e.g., the beacon contract 220, which may be defined on one or more blocks 130 of the blockchain network 125, etc.). The request to establish a proxy contract may include metadata for the contract, which may identify a token type to which the proxy contract is to correspond.

In some implementations, the established proxy contracts may be utilized to mint one or more tokens having the corresponding token type via the blockchain network 125. The client device 120 may transmit requests to establish additional or replacement implementation contracts (e.g., the implementation contracts 230) on the blockchain, and to update the beacon contract with addresses (e.g., the implementation addresses 225) of the new or replacement implementation contracts. Additional requests may also be transmitted, including requests to place one or more wagers, view attributes of an NFT, or to obtain information (e.g., available contests, view selection rules, etc.) related to one or more live events, among others. The requests can be hypertext transfer protocol (HTTP or HTTPS) request messages, file transfer protocol messages, email messages, text messages, or any other type of message that can be transmitted via the network 110.

The blockchain network 125 includes a decentralized system of nodes, e.g., computing systems, each maintaining a copy of the entire blockchain. Nodes of the blockchain network 125 utilize cryptography to enable secure, transparent transactions that are verifiable on blocks 130A-130N (sometimes generally referred to herein as “block(s) 130”) on the blockchain. Each node in the blockchain network 125 can validate new transactions, following a consensus protocol of the blockchain network 125. When a new block 130 is created, the new block 130 can include a list of recent, validated transactions. As shown, each block 130 (including a newly created block 130) is linked to the previous block 130 of the blockchain. The link may be generated via a cryptographic hash, creating a “chain” of blocks.

The blocks 130 of the blockchain network 125 can each include a list of transactions that have been validated by the nodes of the blockchain network 125, a reference to the previous block in the chain, state data of the blockchain, ommers, as well as encoded bytecode for one or more smart contracts. Blockchain networks 125 are secure because, to tamper with a transaction, an attacker would need to modify the block containing the transaction, as well as all subsequent blocks. Due to the distributed nature of the blockchain network 125, doing so would exceed the combined computational power of the entire network, thereby making the blockchain secure against such attacks. Smart contracts, which are self-executing contracts with the terms of the agreement that are directly written into code, can also be hosted on the blockchain, enabling decentralized applications that may be capable of minting tokens.

Smart contracts include digital programs that execute predefined rules or conditions when deployed onto the blockchain network 125 (e.g., in a corresponding block 130). Smart contracts include self-executing contracts with terms of the agreement being directly written into code. These terms can include everything from simple transactions (like sending a certain amount of cryptocurrency from one wallet to another) to complex logic. Smart contracts are compiled into bytecode and then deployed onto the blockchain by creating a transaction that includes the bytecode of the smart contract, which is then broadcast to the blockchain network 124. Once the transaction is confirmed, the smart contract becomes a part of the blockchain, assigned with a unique address in a block 130. Smart contracts described herein can be executed to perform various functionality, including minting tokens (e.g., NFTs such as ERC-721 tokens, etc.).

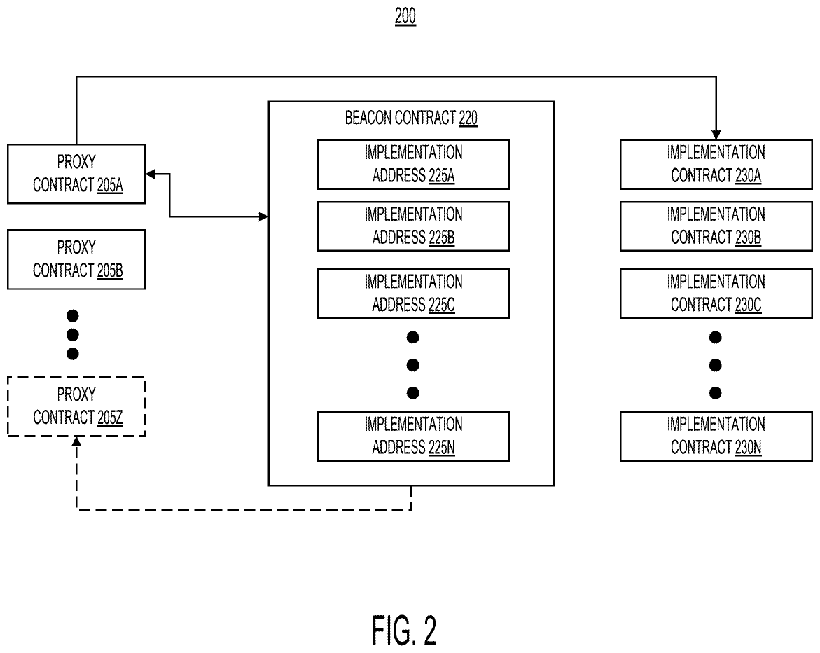

Smart contracts may also cause the blockchain network 125 to execute (e.g., invoke) other smart contracts on the network, using a corresponding address of the smart contract that is to be executed, along with any parameters or arguments that are to be passed to said smart contract. Smart contracts may be able to store certain information, including lists of addresses to other contracts (e.g., lists of implementation addresses such as the implementation addresses 225 described in connection with FIG. 2). For example, a beacon contract (e.g., the beacon contract 220) may receive requests to provide addresses of an up-to-date version of a particular implementation contract (e.g., for minting a particular token with certain attributes, etc.). The beacon contract can return the address of the requested up-to-date implementation contract for execution.

The storage 117 can be a computer-readable memory that can store or maintain any of the information described herein. The storage 117 can store or maintain one or more data structures, which may contain, index, or otherwise store each of the values, pluralities, sets, variables, vectors, numbers, or thresholds described herein. The storage 117 can be accessed using one or more memory addresses, index values, or identifiers of any item, structure, or region maintained in the storage 117. The storage 117 can be accessed by the components of the data processing system 105, or any other computing device described herein, via the network 110. In some implementations, the storage 117 can be internal to the data processing system 105. In some implementations, the storage 117 can exist external to the data processing system 105 and may be accessible via the network 110. The storage 117 can be distributed across many different computer systems or storage elements, and may be accessed via the network 110 or a suitable computer bus interface. The data processing system 105 can store, in one or more regions of the memory of the data processing system 105 or in the storage 117, the results of any or all computations, determinations, selections, identifications, generations, constructions, or calculations in one or more data structures indexed or identified with appropriate values.

Any or all values stored in the storage 117 may be accessed by any computing device described herein, such as the data processing system 105, to perform any of the functionalities or functions described herein. In some implementations, a computing device, such as a client device 120, may utilize authentication information (e.g., username, password, email, etc.) to show that the client device 120 is authorized to access requested information in the storage 117. The storage 117 may include permission settings that indicate which users, devices, or profiles are authorized to access certain information stored in the storage 117. In some implementations, instead of being internal to the data processing system 105, the storage 117 can form a part of a cloud computing system. In such implementations, the storage 117 can be a distributed storage medium in a cloud computing system and can be accessed by any of the components of the data processing system 105, by the one or more client devices 120 (e.g., via one or more user interfaces, etc.), or any other computing devices described herein.

The storage 117 can store or otherwise maintain one or more player profiles 170, for example, in one or more data structures. Each player profile 170 can be associated with a corresponding player (e.g., a user) of a client device 120 that accesses the functionality of the data processing system 105. In implementations where the data processing system 105 can operate without using a client device 120 (e.g., a slot machine, a video game machine, a standalone kiosk, etc.), a player profile 170 may correspond to a player that accesses the data processing system 105 to place wagers, enter contests, or access token metadata 185 of one or more tokens associated with the player profile.

The data processing system 105 may correspond to a central wallet address, which is recorded on the blockchain as storing, or “owning” various tokens minted according to the techniques described herein. In some implementations, each player profile 170 may include a list of tokens that are maintained by the central wallet and owned by the corresponding player of the player profile 170. In some implementations, the data processing system 105 can maintain a table or other data structure associating a token with a respective player profile 170 that owns said token, if any. The table or data structure may include an indication that a token is not owned. The data processing system 105 can update the list of tokens as the player acquires, sells, or trades tokens. A client device 120 may, in some implementations, transmit requests to access the list of tokens of the player profile 170 of the player using the client device 120. In response, the data processing system can access the player profile 170 to identify the tokens owned by the player. In some implementations, the data processing system can access the token metadata 185 corresponding to the tokens identified in the player profile 170, to perform updates (e.g., in response to changes in contest status) or to provide the token metadata 185 in the form of content to the client device 120 for display.

Each player profile 170 can be a user profile that includes information about a user (sometimes referred to as a “player”). Each player profile 170 may include information about one or more of the client devices 120 used to access the data processing system 105 using the player profile 170. For example, identifiers of a player profile 170 can be used to access the functionality of the data processing system 105 via the network 110. In some implementations, a player profile 170 may include a private key. The private key can be used to access or associate one or more tokens with the player profile 170, in some implementations. A private key may indicate to or confirm for the data processing system 105 that a player owns one or more token(s).

The identifiers of player profiles 170 can include a username, a password, an e-mail address, a phone number, a personal identification number (PIN), a secret code-word, a private key or device identifiers for use in a two-factor authentication technique, among others. The player profile 170 can store historical information about contests, such as contests viewed, selected, wagered upon (including, e.g., parlay wagers), or entered using the tokens identified in the player profile 170, or live event outcomes, or other historical information. The player profile 170 can store a credit balance or wager information (e.g., an amount of a wager, a timestamp associated with a wager, information about the presence of an indication to participate in a bonus opportunity using the wager, a client device identifier of a client device 120 that was used to submit a lineup, tokens, or other information or entry data to a contest, the number of contests played using the player profile 170, etc.). The player profile 170 can store indicators of outcomes of contests that the corresponding player has entered.

The player profile 170 can store information about a client device 120 used to access the data processing system 105, such as an internet protocol (IP) address, a media access control (MAC) address, a global unique identification (GUID), a player profile 170 name (e.g., the name of the user of the client device 120, a player-chosen username, etc.), or a device name, among others. In some implementations, a player profile 170 can be created by the data processing system 105 in response to a player profile 170 creation request transmitted by a client device 120. The player profile 170 creation request can include any of the player profile 170 information described herein. In some implementations, a client device 120 accessing the data processing system 105 may not be associated with a player profile 170. In such implementations, the data processing system 105 can automatically create a player profile 170 using an identifier of the client device 120 provided by the client device 120.

The storage 117 can store contract addresses 180, including addresses of a beacon contract (e.g., the beacon contract 220), proxy contracts (e.g., the proxy contracts 205A-205Z), and/or implementation contracts (e.g., the implementation contract 230A-230C). The contract addresses may be, in some implementations, an identifier value (e.g., a hexadecimal string) that uniquely identifies a respective smart contract (e.g., a beacon contract, a proxy contract, an implementation contract, etc.) on the blockchain 125. A contract address 180 can be used by the data processing system 105 to interact with the contract which the contract address 180 corresponds. For example, to call a function of a contract via the blockchain network 125, the corresponding contract address 180 can be specified in the function call (e.g., in a request). Smart contract addresses 180 can be generated via the blockchain network 125 when a smart contract is created on via the blockchain network 125.

Interactions (e.g., requests, function calls, etc.) can be provided to the blockchain network 125 to invoke a contract by transmitting one or more transactions to a contract address 180 identifying the contract. The transaction may include additional information that is provided as parameters for the smart contract, which may be encoded as part of the transaction. Particular functions of a smart contract, which are executed via the blockchain network 125, may be identified using a corresponding function signature, which uniquely identifies the function within the smart contract. A contract address 180 may be stored in association with a list of function signatures included in the smart contract to which the contract address 180 corresponds, and can be utilized by the components of the data processing system 105 when transmitting commands to invoke functions of smart contracts as described herein. Functions of smart contracts invoked on and executed via the blockchain network 125 can emit events, which are logged to one or more blocks 130 written to the blockchain. The logs can be queried, for example, by the data processing system 105 to retrieve the results of executing any smart contracts (e.g., addresses of newly deployed smart contracts, addresses of implementation contracts, etc.).

Referring now to the operations of the data processing system 105, the contract manager 135 can manage the deployment of one or more smart contracts (e.g., the beacon contract 220, etc.) on the blockchain via the blockchain network 125. The contract manager 135 may provide a beacon contract that includes instructions to both deploy proxy contracts (e.g., proxy contracts 205A-205Z) in response to corresponding requests while maintaining a list of addresses (e.g., the implementation addresses 225A-225N) for corresponding implementation contracts (e.g., the implementation contracts 230A-230N) stored on the blockchain. The beacon contract may serve as a “factory” for proxy contracts. The proxy contracts may be implemented to provide an interface to one or more implementation contracts. The beacon contract can include any number of functions, each associated with a respective signature, to update implementation contract addresses, or to deploy additional proxy contracts corresponding to respective types of tokens.

The contract manager 135 may provide (e.g., deploy) one or more implementation contracts onto the blockchain via the blockchain network 125. An implementation contract may include functions that perform various processing operations involving a respective token type. Non-limiting example token types include ERC-721 tokens, ERC-20 tokens, ERC-1155 standard data, ERC-998 tokens, ERC-1046 tokens, or ERC-994 tokens, among others. Although these example tokens are described in connection with the Ethereum blockchain, it should be understood that the techniques described herein may be implemented using any type of blockchain. Non-limiting example processing operations include minting a token, burning a token, transferring a token to a destination address, or updating token metadata, among other operations. The contract manager 135 may provide any of the contracts described herein onto the blockchain by transmitting a corresponding transaction to the blockchain network 125. The blockchain network 125 can then record the contracts in corresponding block(s) 130 on the blockchain.

The contract manager 135 may update state data associated with one or more contracts. For example, in some implementations, a list of addresses to different implementation contracts may be stored as contract state data (e.g., one or more state variables) of the beacon contract. The state data of the beacon contract, including any of the list of addresses of implementation contracts, may be changed by invoking one or more functions (e.g., associated with respective function signatures in the contract addresses 180) of the beacon contract. The functions may include functions to add, remove, or modify one or more implementation contract addresses. The contract manager 135 can invoke one or more of said functions by transmitting a transaction identifying the beacon contract address and one or more corresponding function signatures (and any encoded parameter data) as part of a transaction. The encoded parameter data may include an address of a new implementation contract deployed by the contract manager 135 onto the blockchain.

The factory invoker 145 can invoke one or more functions of the beacon contract to deploy one or more additional proxy contract(s), for example, in response to a request from an operator of the data processing system 105 or from one or more client devices 120. The first proxy contract can correspond to a particular token type, which is specified in the request to deploy the additional proxy contract. Invoking the beacon contract to deploy the new contract includes transmitting a transaction identifying the beacon contract address and one or more corresponding function signatures (and any encoded parameter data) as part of a transaction to the blockchain network 125, causing the blockchain network 125 to execute the function(s) of the beacon contract to generate the additional proxy contract on the blockchain. The proxy contract may be deployed as an additional instance of another contract previously deployed on the blockchain (e.g., a proxy contract template deployed via the contract manager 135). The previously deployed proxy contract from which the instances are created can include a constructor function (and corresponding signature) that enables configuration of the proxy contract at deployment (e.g., to initialize variables of the deployed contract, control program logic of the deployed contract, etc.).

The function (sometimes referred to as a “factory function”) of the beacon contract can be executed via the blockchain network 125 to determine that the list of implementation contracts maintained by the beacon contract includes an implementation contract corresponding to the token type of the additional proxy contract that is to be deployed. The implementation contracts can include operations that are specific to the token type (e.g., the token standard), such as minting, burning, transfers, or any other operation that may involve a token of a particular type. If an implementation contract for the requested type of token is not maintained in the list of addresses of the beacon contract, the function may return an error. If the implementation contract for the requested type of token is maintained in the list of addresses, the blockchain network 125 may continue to execute the factory function to generate the additional proxy contract, on the blockchain. When generating the additional proxy contract by deploying an additional instance of the proxy contract on the blockchain, a constructor function of the proxy contract is executed to cause the additional proxy contract to maintain the address of the beacon contract in its state data.

When the additional proxy contract is deployed, the beacon contract is returned an address of the additional proxy contract. In some implementations, the address of the additional proxy contract can be provided on the blockchain as an event in a log. In some implementations, the address can be stored in one or more state variables of the beacon contract, which may be queried by the factory invoker 145 by transmitting a corresponding transaction to invoke a function that returns the value of said one or more state variables, thereby returning the address of the additional proxy contract. The factory invoker 145 can then store the address of the newly deployed proxy contract as part of the contract addresses 180, along with any corresponding function signatures for the functions of the newly deployed proxy contract.

The proxy invoker 155 can invoke any of the deployed proxy contracts, for example, to mint a token of a particular type, or perform any other type of processing operation involving a particular token type. The proxy invoker 155 may cause execution of one or more functions of the proxy contract, for example, in response to a corresponding request from an operator of the data processing system 105 or from a client device 120. The proxy invoker 155 can invoke one or more of said functions by transmitting a transaction identifying the proxy contract address (e.g., corresponding to the token type and maintained in the contract addresses 180) and one or more corresponding function signatures (and any encoded parameter data) as part of a transaction to the blockchain network 125.

In response to the transaction, the blockchain network 125 can execute the specified function(s) of the proxy contract. For example, the proxy contract may cause one or more computing systems of the blockchain network 125 to call a function of the beacon contract (using the address of the beacon contract maintained in the proxy contract) to retrieve the address of the implementation contract corresponding to the token type of the proxy contract. The proxy contract can then invoke the implementation contract to perform one or more processing operations for the token type, such as minting, transferring, or burning one or more tokens on the blockchain.

In one example, the proxy invoker 155 can monitor the progress the progress of the processing operations using a transaction hash for the transaction. In an example where the proxy contract was invoked to mint one or more tokens, the proxy invoker 155 may determine whether the tokens have been minted. Furthering this example, the proxy invoker 155, or the data processing system 105, may be a node of the blockchain network 125. In some implementations, the proxy contract (or the implementation contract invoked thereby) may emit events over the blockchain network 125 during the minting process (or other processing tasks) that can be detected, for example, by querying event logs of the proxy contract or the implementation contract. Events may include information about the successful minting of tokens, such as the number of tokens minted and the address to which they were assigned, among other information relating to processing tasks that may be performed via the implementation contract.

In an example where the processing involves minting one or more tokens, the proxy invoker 155 may verify the token balance of the wallet address associated with the data processing system 105 (e.g., the central wallet). By querying the blockchain or using appropriate wallet interfaces, the proxy invoker 155 can determine that the tokens have been successfully minted and added to the central wallet. If the token balance reflects the expected minted tokens (e.g., the proxy invoker 155 determines that the token(s) have been transferred to the wallet address of the central wallet), it indicates that the minting process has completed. The proxy invoker 155 may perform similar techniques to determine whether other processing tasks involving tokens and executed via one or more corresponding implementation contracts have been completed. Further details of the beacon contract, the proxy contracts, and the implementation contracts are described in connection with FIG. 2.

Referring to FIG. 2 within the context of the components described in connection with FIG. 1, an example dataflow diagram 200 is illustrated showing how a beacon contract 220 can deploy proxy contracts 205A-205Z (sometimes referred to herein as the “proxy contract(s) 205”) and maintain lists of implementation contract addresses 225A-225N (sometimes referred to herein as the “implementation contract address(es) 225”) corresponding to respective implementation contracts 230A-230N (sometimes referred to herein as the “implementation contract(s) 230”). As described herein, the beacon contract 220, the proxy contracts 205, and the implementation contracts 230 can include smart contracts defined on a blockchain (e.g., the blockchain formed from the blocks 130 and maintained by the distributed blockchain network 125).

The beacon contract 220 can include functions that enable the beacon contract 220 to deploy (e.g., create additional instances of) a proxy contract 205 on the blockchain. As described herein, a proxy contract 205 may correspond to a particular token type, which may be assigned during creation of the proxy contract. The proxy contract may include functions that, when executed by the blockchain network 125 in response to corresponding transaction requests on the blockchain, can cause the proxy contract 205 to make a corresponding function call to the beacon contract to retrieve the implementation address 225 of a corresponding implementation contract 230. The implementation addresses 225 stored by the beacon contract identify an up-to-date implementation contract 230 stored on the blockchain. Although the executable code of smart contracts on the blockchain are immutable, an implementation contract 230 can be effectively updated by deploying a new implementation contract 230 on the blockchain, and updating a corresponding implementation contract address 225 to identify the new implementation 230.

Deploying a new contract on the blockchain can include creating a new instance of a contract by executing instructions to create a copy of a pre-existing contract on the blockchain, while executing one or more functions (e.g., constructor functions) to initialize state data (e.g., state variables) of the contract. For example, the contract manager 135 may deploy, using a transaction request, an initial proxy contract that is to be replicated to create the proxy contracts 205 on the blockchain. In response to transaction requests that invoke corresponding functions of the beacon contract 220, the blockchain network 125 can create an additional copy of the initial proxy contract for a particular token type. For example, the token type, along with an address of the beacon contract, can be stored as part of the state data of the new proxy contract 205. In the example dataflow diagram 200 of FIG. 2, the beacon contract 220 is shown as creating the proxy contract 205Z, while the other proxy contracts 205 are already defined on the blockchain. The beacon contract 220, upon creating the proxy contract 205Z on the blockchain, can return an address of the proxy contract 205Z to the data processing system 105, as described herein.

Proxy contracts 205 can be utilized to enable upgradable smart contract functionality via the beacon contract 220. As shown, the beacon contract 220 can maintain a list of implementation contract address 225A-225N, each of which respectively identify corresponding implementation contracts 230A-230N, which are smart contracts defined on the blockchain. In some implementations, each implementation contract address 225 in the list can be stored in association with an identifier of a token type to which the corresponding implementation contract 230 corresponds. When a request to create an additional proxy contract 205 is received, the blockchain network 125 can execute one or more functions of the beacon contract 220 to determine whether the list of implementation contract addresses 225 includes an implementation contract corresponding to processing of the token type specified in the request. For example, if the request is a request to create an additional proxy contract 205 for processing ERC-721 tokens, the request can cause the blockchain network 125 to determine whether the list includes an address 225 of an implementation contract 230 for processing (e.g., minting, transferring, burning, etc.) ERC-721 tokens. If the implementation contract 230 is present, the blockchain network 125 can perform the operations described herein to create the additional proxy contract 205Z and return the address identifying the same.

The beacon contract 220 can further include instructions to provide addresses 225 for implementation contracts 230 in response to corresponding requests from proxy contracts 205. As described herein, the proxy contracts 205 and the beacon contract 220 implement a beacon proxy scheme, which provides an interface to upgradeable smart contracts (e.g., the implementation contracts 230). When a transaction is made to invoke a proxy contract 205 (in this example, the proxy contract 205B), the beacon contract 220 can retrieve the implementation address 225 corresponding to the up-to-date implementation contract 230 queried by the proxy contract 205, and provide the implementation address 225 to the requesting proxy contract 205. In the example shown in the dataflow diagram 200, the proxy contract 205A requests the address of the implementation contract 230A. In response to the request, the beacon contract 220 can provide the implementation address 225A (which identifies the implementation contract 230A on the blockchain) to the proxy contract 205A.

The proxy contract 205A can then utilize the implementation address 225A to access and invoke the implementation contract 230A. For example, the proxy contract 205A can invoke one or more functions of the implementation contract 230A to mint one or more tokens on the blockchain having the token type (e.g., ERC-721) associated with the implementation contract 230A. As described herein, the implementation contract 230A may provide functions to perform any type of processing involving tokens minted on the blockchain, including transferring, burning, or minting tokens. It should be understood that multiple, different proxy contracts 205 may request access to the same or different implementation contracts 230 to perform token processing. For example, in some implementations, a proxy contract 205 may invoke multiple implementation contracts 230 to process multiple types of tokens. Likewise, different proxy contracts 205 may invoke the same implementation contract 230 to process the same type of token, but with different parameters. The techniques described herein may be utilized to replace the implementation contract addresses 225 with addresses of up-to-date implementation contracts 230 newly provided on the blockchain, effectively enabling the proxy contracts 205 to execute upgraded versions of the implementation contracts 230. The beacon contract 220 coordinates both the creation of new proxy contracts 205 and the upgrading or addition of new implementation contracts 230 using the techniques described herein.

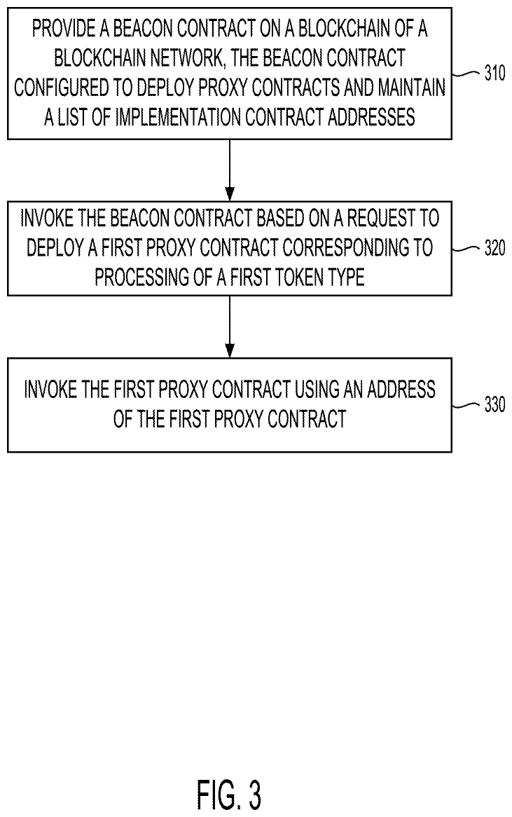

FIG. 3 illustrates a flow diagram of an example method 300 of providing improved and upgradable smart contract factories (e.g., the beacon contract 220), in accordance with one or more implementations. The method 300 may be performed, for example, by the data processing system 105, the client device 120, one or more nodes of the blockchain network 125, or any other computing system described herein.

Although the method 300 is described as being performed by the data processing system 105, it should nevertheless be understood that any computing device may perform the various operations of the method 300 and communicate any results of the operations or intermediate computations relating to the operations to any other computing device described. The method 300 is described as having steps 310-330. However, it should be understood that the steps (referred to as ACTs) may be performed in any order, and that steps may be omitted or added to achieve useful results.

At ACT 310, the data processing system (e.g., the data processing system 105) can provide, on a blockchain of a blockchain network (e.g., the blockchain network 125), a beacon contract (e.g., the beacon contract 220) configured to (i) deploy proxy contracts (e.g., the proxy contract(s) 205) in response to corresponding requests and (ii) maintain a list (e.g., the implementation contract addresses 225) of a one or more implementation contracts (e.g., the implementation stored on the blockchain. Each implementation contract may correspond to a respective token type (e.g., a token established according to a respective token standard). Providing the beacon contract may include transmitting a transaction request including the code for the beacon contract to the blockchain network, with one or more instructions to define the beacon contract on the blockchain network.

Upon transmitting the request, the blockchain network may return the address of the beacon contract to the data processing system, which can use the address to implement the functionality of the beacon contract. For example, the data processing system may transmit requests to update the implementation contract addresses maintained in state data variables of the beacon contract. The state data variables may be updated by transmitting corresponding function call requests via transactions on the blockchain network. For example, the data processing system may deploy one or more new or replacement implementation contracts onto the blockchain (e.g., with new or updated code), and transmit corresponding transactions to update the list of implementation contract addresses with the new or replacement implementation contracts defined on the blockchain. The data processing system may also transmit transaction requests to execute functions of the beacon contract to create new instances of proxy contracts, as described herein.

At ACT 320, the data processing system can invoke the beacon contract based on a request (e.g., a transaction on the blockchain network identifying the beacon contract and one or more function signatures that implement contract factory functionality) to deploy a first proxy contract. The first proxy contract may correspond to processing of a first token type (e.g., a particular specified token standard) that is identified in encoded parameters of the transaction and provided as parameters to the function(s) of the beacon contract that create the new instances of the proxy contract via the blockchain network.

The invocation of the beacon contract (e.g., in response to the transaction) can cause the blockchain network to determine that the list of the plurality of implementation contracts includes an implementation contract corresponding to the first token type. For example, the beacon contract can include instructions that cause the blockchain network to determine whether the state data variables stored via the beacon contract store an address for an implementation contract including functions to process tokens having the first token type. If the beacon contract does not maintain an address for such an implementation contract, the beacon contract may return an error. Otherwise, the beacon contract can proceed to generate an additional instance of the proxy contract on the blockchain. The additional instance may be initialized with parameters provided via the transaction to request generation of the additional proxy contract, including the address of the beacon contract and the type of token associated with the proxy contract. The blockchain network can then provide, on the blockchain (e.g., in an event log, as a return value), an address for the newly created proxy contract in response to the request.

In some implementations, the data processing system can monitor the progress of the transaction, for example, via one or more event logs to determine whether the new proxy contract has been created on the blockchain. When it is detected that the proxy contract has been created, the data processing system may provide an indication (e.g., a notification, a message, etc.) that the proxy contract has been deployed on the blockchain. The indication comprising the second address of the first proxy contract. The data processing system can then store the address of the proxy contract in a storage system (e.g., the storage 117, the database 115, etc.) different from the blockchain. The data processing system can then invoke the proxy contract to perform processing operations involving tokens of the corresponding token types.

At ACT 330, the data processing system can invoke the created proxy contract (e.g., the proxy contract 205Z) on the blockchain using the address of the proxy contract. Invoking the proxy contract on the blockchain can cause the blockchain network to execute the executable instructions of the proxy contract to retrieve an address of the implementation contract corresponding to the first token type via the beacon contract. For example, the proxy contract can make a function call to the beacon contract using the address of the beacon contract provided when the proxy contract was created. In some implementations, the data processing system may transmit transactions including instructions to update the address of the beacon contract (e.g., as part of one or more state data variables) stored via one or more proxy contracts.

Upon invoking the function of the beacon contract, the blockchain network can retrieve an address of the requested implementation contract corresponding to the token type of the proxy contract. Doing so may cause the blockchain network to select an identifier of the implementation contract corresponding to the token type from the list of implementation contracts maintained via the state data of the beacon contract. The identifier (e.g., address) of the implementation contract corresponding to the token type may be provided as a return value of the function calls to the beacon contract. The proxy contract may then proceed to execute one or more functions of the implementation contract according to the transaction originally provided to the proxy contract. For example, if the transaction was to mint one or more tokens on the blockchain, the proxy contract may utilize the address of the implementation contract to invoke one or more minting functions provided by the implementation contract.

Invoking such functions can cause the blockchain network to generate one or more token having the token type of the implementation contract. As described herein, the data processing system may monitor the progress of the transaction on the blockchain via one or more event logs to determine whether the token(s) have been minted. Upon receiving confirmation that the token has been generated, the data processing system store a set of metadata (e.g., corresponding token metadata 185) for the token in a storage system (e.g., the storage 117, the database 115) different from the blockchain. The token metadata may identify one or more unique identifiers for the minted tokens, along with any other metadata (e.g., rarity values, edition numbers, etc.) associated with the tokens.

The data processing system may deploy additional or replacement implementation contracts on the blockchain as part of a process to “upgrade” the implementation contracts. Once the implementation contracts have been created on the blockchain, the data processing system can provide one or more requests (e.g. transactions) to update the list of implementation contract addresses stored by the beacon contract (e.g., in one or more state data variables). The request can include the address of the new or replacement implementation contract. In response to the transaction, the blockchain network can add the address of the new or replacement implementation contract in the state data of the beacon contract. In some implementations, the request may specify that one or more previously stored implementation contract addresses stored by the beacon contract is to be replaced in the list by the address of the new implementation contract. In such implementations, the blockchain network can update the state data of the beacon contract to replace the address according to the request.

Referring to FIG. 4, an implementation of a computing system 400 is shown that can be used, for example, to implement the systems and methods described with reference to FIGS. 1, 2, and 3. The computing architecture described in FIG. 4 can be used to implement the data processing system 105, one or more of the client devices 120, or any other computing system described herein. The computing system 400 includes a bus 420 or other communication component for communicating information and a processor 430 coupled to the bus 420 for processing information. The computing system 400 also includes main memory 405, such as a random-access memory (RAM) or other dynamic storage device, coupled to the bus 420 for storing information, and instructions to be executed by the processor 430. The main memory 405 can also be used for storing position information, temporary variables, or other intermediate information during execution of instructions by the processor 430. The computing system 400 may further include a read-only memory (ROM) 410 or other static storage device coupled to the bus 420 for storing static information and instructions for the processor 430. A storage device 415, such as a solid-state device, magnetic disk, or optical disk, is coupled to the bus 420 for persistently storing information and instructions.

The computing system 400 may be coupled via the bus 420 to a display 440, such as a liquid crystal display, or active-matrix display, for displaying information to a user. The display 440 can be any type of display device, including a touchscreen device. An input device 445, such as a keyboard having alphanumeric and other keys, may be coupled to the bus 420 for communicating information, and command selections to the processor 430. The input device 445 can include a touch sensor of the touchscreen display 440. The input device 445 can include a cursor control, such as a mouse, a trackball, or cursor direction keys, for communicating direction information and command selections to the processor 430 and for controlling cursor movement on the display 440.

The computing system 400 can include an interface 425, such as a networking adapter. The interface 425 may be coupled to bus 420 and may be configured to enable communications with a computing or communications network 110 and/or other computing systems. Any type of networking configuration may be achieved using interface 425, such as wired (e.g., via Ethernet), wireless (e.g., via Wi-Fi, Bluetooth, etc.), pre-configured, ad-hoc, LAN, WAN, etc.

According to various implementations, the processes that effectuate illustrative implementations that are described herein can be achieved by the computing system 400 in response to the processor 430 executing an arrangement of instructions contained in main memory 405. Such instructions can be read into main memory 405 from another computer-readable medium, such as the storage device 415. Execution of the arrangement of instructions contained in main memory 405 causes the computing system 400 to perform the illustrative processes described herein. One or more processors in a multi-processing arrangement may also be employed to execute the instructions contained in main memory 405. In alternative implementations, hard-wired circuitry may be used in place of or in combination with software instructions to implement illustrative implementations. Thus, implementations are not limited to any specific combination of hardware circuitry and software.

Although an example processing system has been described in FIG. 4, implementations of the subject matter and the functional operations described in this specification can be carried out using other types of digital electronic circuitry, or in computer software, firmware, or hardware, including the structures disclosed in this specification and their structural equivalents, or in combinations of one or more of them.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the data processing system 105 could be a single module, one or more servers, part of a search engine, or, a logic device having one or more processing modules.

Having now described some illustrative implementations and implementations, it is apparent that the foregoing is illustrative and not limiting, having been presented by way of example. In particular, although many of the examples presented herein involve specific combinations of method acts or system elements, those acts and elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

Instances of “or” may be construed as inclusive so that any terms described using “or” may indicate any of a single, more than one, or all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

What is claimed is:

1. A method, comprising:
providing, by one or more processors coupled to memory, on a blockchain of a blockchain network, a beacon contract configured to (i) deploy proxy contracts in response to corresponding requests and (ii) maintain a list of a plurality of implementation contracts stored on the blockchain, each implementation contract corresponding to a respective token type;
invoking, by the one or more processors, the beacon contract based on a request to deploy a first proxy contract, the first proxy contract corresponding to processing of a first token type, the invocation of the beacon contract causing the blockchain network to:
determine that the list of the plurality of implementation contracts includes an implementation contract corresponding to the first token type;
generate, on the blockchain responsive to the determination, the first proxy contract comprising a first address of the beacon contract; and
provide, on the blockchain, a second address of the first proxy contract in response to the request; and
invoking, by the one or more processors, the first proxy contract on the blockchain using the second address of the first proxy contract.

2. The method of claim 1, further comprising:
storing, by the one or more processors, the second address of the first proxy contract in a storage system different from the blockchain.

3. The method of claim 1, wherein invoking the first proxy contract on the blockchain causes the blockchain network to execute the first proxy contract based on the first address of the beacon contract.

4. The method of claim 3, wherein invoking the first proxy contract causes the blockchain network to retrieve a third address of the implementation contract corresponding to the first token type via the beacon contract.

5. The method of claim 4, wherein retrieving the third address of the implementation contract corresponding to the first token type causes the blockchain network to:
select an identifier of the implementation contract corresponding to the first token type from the list of the plurality of implementation contracts; and
provide the identifier of the implementation contract corresponding to the first token type as the third address of the implementation contract.

6. The method of claim 1, further comprising:
providing, by the one or more processors, a second request to update the implementation contract corresponding to the first token type, the second request comprising an identifier of an additional implementation contract,
wherein the second request causes the blockchain network to replace the identifier of the implementation contract corresponding to the first token type with the identifier of the additional implementation contract.

7. The method of claim 6, further comprising invoking, by the one or more processors, the first proxy contract on the blockchain using the second address of the first proxy contract, causing the blockchain network to retrieve the identifier of the additional implementation contract via the beacon contract.

8. The method of claim 1, further comprising causing, by the one or more processors, generation of a token having the first token type by invoking the implementation contract corresponding to the first token type via a second request identifying the first proxy contract.

9. The method of claim 8, further comprising:
upon receiving confirmation that the token has been generated, storing, by the one or more processors, a set of metadata corresponding to the token in a storage system different from the blockchain.

10. The method of claim 1, further comprising:
determining, by the one or more processors, that the first proxy contract has been deployed on the blockchain; and
providing, by the one or more processors, an indication that the first proxy contract has been deployed on the blockchain, the indication comprising the second address of the first proxy contract.

11. A system, comprising:
one or more processors coupled to non-transitory memory, the one or more processors configured to:
provide, on a blockchain of a blockchain network, a beacon contract configured to (i) deploy proxy contracts in response to corresponding requests and (ii) maintain a list of a plurality of implementation contracts stored on the blockchain, each implementation contract corresponding to a respective token type;
invoke the beacon contract based on a request to deploy a first proxy contract, the first proxy contract corresponding to processing of a first token type, the invocation of the beacon contract causing the blockchain network to:
determine that the list of the plurality of implementation contracts includes an implementation contract corresponding to the first token type;
generate, on the blockchain responsive to the determination, the first proxy contract comprising a first address of the beacon contract; and
provide, on the blockchain, a second address of the first proxy contract in response to the request; and
invoke the first proxy contract on the blockchain using the second address of the first proxy contract.

12. The system of claim 11, wherein the one or more processors are further configured to:
store the second address of the first proxy contract in a storage system different from the blockchain.

13. The system of claim 11, wherein invoking the first proxy contract on the blockchain causes the blockchain network to execute the first proxy contract based on the first address of the beacon contract.

14. The system of claim 13, wherein invoking the first proxy contract causes the blockchain network to retrieve a third address of the implementation contract corresponding to the first token type via the beacon contract.

15. The system of claim 14, wherein retrieving the third address of the implementation contract corresponding to the first token type causes the blockchain network to:
select an identifier of the implementation contract corresponding to the first token type from the list of the plurality of implementation contracts; and
provide the identifier of the implementation contract corresponding to the first token type as the third address of the implementation contract.

16. The system of claim 11, wherein the one or more processors are further configured to:
provide a second request to update the implementation contract corresponding to the first token type, the second request comprising an identifier of an additional implementation contract,
wherein the second request causes the blockchain network to replace the identifier of the implementation contract corresponding to the first token type with the identifier of the additional implementation contract.

17. The system of claim 16, wherein the one or more processors are further configured to:
invoke the first proxy contract on the blockchain using the second address of the first proxy contract, causing the blockchain network to retrieve the identifier of the additional implementation contract via the beacon contract.

18. The system of claim 11, wherein the one or more processors are further configured to:
cause generation of a token having the first token type by invoking the implementation contract corresponding to the first token type via a second request identifying the first proxy contract.

19. The system of claim 18, wherein the one or more processors are further configured to:
upon receiving confirmation that the token has been generated, store a set of metadata corresponding to the token in a storage system different from the blockchain.

20. The system of claim 11, wherein the one or more processors are further configured to:
determine that the first proxy contract has been deployed on the blockchain; and
provide an indication that the first proxy contract has been deployed on the blockchain, the indication comprising the second address of the first proxy contract.
